(19) United States
(12) Patent Application Publication
(10) Pub. No.: US 2020/0271318 A1
(43) Pub. Date: Aug. 27, 2020

(54) COMBUSTION CHAMBER ASSEMBLY WITH SHINGLE MEMBER AND BASE BODIES ALIGNED THEREWITH, EACH CARRYING A FASTENING ELEMENT, AND METHOD OF MANUFACTURING

(71) Applicant: Rolls-Royce Deutschland Ltd & Co KG, Blankenfelde-Mahlow (DE)

(72) Inventors: Michael EBEL, Rangsdorf (DE); Kay HEINZE, Ludwigsfelde (DE); Miklos GERENDAS, Am Mellensee (DE); Igor SIKORSKI, Berlin (DE)

(21) Appl. No.: 16/793,773

(22) Filed: Feb. 18, 2020

(30) Foreign Application Priority Data
Feb. 22, 2019 (DE) 10 2019 202 466.1

(51) Int. Cl. F23R 3/00

(52) U.S. Cl. CPC F23R 3/002; F05D 2240/35; F05D 2230/60; F23R 2900/00017

(57) ABSTRACT

A combustion chamber assembly for an engine, with a tile component fixed to a combustion chamber component and having a hot side facing a combustion space and a cold side facing away from the combustion space and facing towards the combustion chamber component, wherein the tile component on the cold side has at least four fixing elements each arranged eccentrically on the tile component for fixing the tile component to the combustion chamber component. The four base bodies are here oriented with their respective at least one side passage opening towards a reference point lying on a center line of the tile component, so that a respective cavity of the respective base body is open in the direction of the reference point.

This application claims priority to German Patent Application DE102019202466.1 filed Feb. 22, 2019, the entirety of which is incorporated by reference herein.

### DESCRIPTION

The proposed solution concerns a combustion chamber assembly for an engine with at least one tile component, and a production method.

A tile component, e.g. in the form of a heat shield or combustion chamber tile, is fixed to a combustion chamber component which is part of a combustion chamber structure surrounding a combustion space for an engine. For example, the combustion chamber component may be a combustion chamber wall. The tile component has a hot side facing the combustion space, and a cold side facing away from the combustion space and facing towards the combustion chamber component, and extends in two mutually perpendicular spatial directions. Accordingly, the tile component forms a shield surface on the hot side in order to protect the combustion chamber component from the high temperatures prevailing inside the combustion space during operation of the engine.

To fix the tile component to the combustion chamber component, fixing elements are provided, typically in the form of bolts, in particular threaded bolts, on the cold side of the tile component; said bolts are inserted in corresponding fixing openings of the combustion chamber component and then fixed thereto e.g. via a nut. For defined fixing of the tile component, typically at least four fixing elements are provided which are each arranged eccentrically on the cold side of the tile component.

To cool the tile component, it is furthermore known to provide cooling holes on the tile component via which cooling fluid, typically cooling air, can be conducted to the hot side of the tile component. Furthermore, usually also so-called mixing air holes are provided e.g. on a combustion chamber tile as a tile component, which holes serve to conduct air into the combustion space for cooling and leaning out the combustion.

EP 3 369 996 A1 discloses providing fixing elements for a tile component on a base body protruding on the cold side in order to achieve a cooling of the tile component also in the region of the fixing element. Without such a base body, for example the foot of a fixing element via which the fixing element is attached to the tile component, e.g. welded or molded, is not effectively cooled; this could lead to undesirable creep and subsequent failure of the fixing element. To address this problem, EP 3 369 996 A1 proposes to provide a fixing element mounted on a platform of the base body protruding on the cold side, and to form a cavity below the platform which is open towards the cold side via at least one side passage opening on the base body. Via the at least one side passage opening, cooling fluid can then flow below the platform in order to provide targeted cooling of the tile component also in the region of the fixing element. This supports a homogenous temperature distribution at the tile component, and can significantly extend the service life of the tile component.

It has now been shown that disadvantageous load concentrations can occur with regard to the provision of a homogenous cooling film. Thus in operation of the engine, because of the temperature differences and different thermal expansion coefficients of the materials used, thermal expansions of differing extents occur at the combustion chamber component and tile component, which can lead to shear loads on the fixing elements. This may be associated with additional loads at connecting regions adjoining a side passage opening and connecting the base body platform carrying the fixing element to the cold side of the tile component. In this context, there is a need for a further improvement of a combustion chamber assembly with a tile component on which fixing elements are provided on a respective base body on a cold side of the tile component.

The proposed solution now provides that a tile component of a combustion chamber assembly has at least four base bodies for at least four eccentrically arranged fixing elements on a cold side. The at least four base bodies are here distributed about a central region of the tile component, relative to the extension of the tile component along the two mutually perpendicular spatial directions, so that in each case two base bodies, each with a fixing element, are provided on different halves of the tile component relative to a center line extending in a first spatial direction of the two mutually perpendicular spatial directions. The halves of the tile component thus succeed one another in the first spatial direction. Such a configuration is described for example in DE 10 2018 213 925.3. Furthermore, the four base bodies are here each oriented with their respective at least one side passage opening towards a reference point lying on the center line, so that the cavity of the respective base body is open in the direction of the reference point via the at least one side passage opening.

The proposed solution is thus based on the basic concept of arranging four base bodies carrying fixing elements on the cold side of the tile component in a defined fashion, with their side passage openings oriented towards a reference point provided in a central region. It has been shown that via this measure, stresses occurring in the region of the base body and the fixing elements during operation of the engine (for example due to the different thermal expansions) can be substantially reduced, whereby the expected service life of the tile component and/or combustion chamber assembly can be increased. This selected arrangement guarantees, via the four base bodies arranged eccentrically and spaced apart from each other, each with a fixing element, that the load on the individual fixing elements is even and as symmetrical as possible relative to the tile component. The proposed arrangement thus ensures that connecting regions of a respective base body adjoining the respective side passage opening, via which the associated platform is connected to the cold side of the tile component and the edges of which towards a passage opening are most heavily loaded under the thermal expansion occurring in operation of the engine, are oriented in targeted fashion towards the connecting regions of the further base bodies and hence the further fixing points of the tile component. This takes account of the fact that during operation of the engine, the tile component expands precisely radially to a longitudinal axis of the respective fixing element, which results in said shear loads on the platforms and the connecting regions connecting a respective platform to the cold side of the tile component. With the arrangement of the base bodies provided according to the proposed solution, in targeted fashion such local stresses can be balanced over the tile component and hence as a whole reduced, which in turn leads to said extension of the service life of the tile component and/or the combustion chamber assembly comprising the tile component.

The proposed solution may be provided in particular in connection with a combustion chamber tile as a tile component.

One embodiment variant provides that, in top view onto the cold side, an outer contour of each side passage opening of the four base bodies intersects an outermost peripheral line of the respective base body at two points, and a connecting axis through these two (intersection) points runs at an angle in the range from 60° to 120° to a force action line which connects the reference point to a longitudinal axis of the fixing element of the respective base body. The angle between the connecting axis and the force action line may in particular lie in the range from 80° to 100°, in the range from 85° to 95° or at 90°. In the latter case, accordingly the connecting axis and the force action line run perpendicularly to each other. The arrangement of the connecting axis, characterizing the extent of a side passage opening, as perpendicularly as possible to the force action line may here avoid loads on the connecting regions of the base bodies, which are otherwise locally loaded with higher stresses and each adjoin a side passage opening, and hence support the balancing of the stresses over the tile component.

An orientation of the base body towards the reference point, which may deviate from a 90° course of a connecting axis to a force action line, may here for example be due to a production process in which the base body and fixing element are provided on the cold side of the tile component. If for example a powder-metallurgical, additive laser welding process is provided, a necessary orientation of production and transition ramps may require a certain deviation from a 90° orientation. In some cases also aid ramps may be used, which must later be removed in order to achieve an orientation in the region of 90°.

In one embodiment variant, the reference point is provided on an intersection point of a first force action line and a second force action line, wherein in top view onto the cold side
the first force action line runs from a first longitudinal axis of a first fixing element of a first base body, provided on a first half of the two different halves of the tile component, to a third longitudinal axis of a third fixing element of a third base body which is provided on the other, second half, and
the second force action line runs from a second longitudinal axis of a second fixing element of a second base body, also provided on the first half of the tile component, to a fourth longitudinal axis of a fourth fixing element of a fourth base body which is in turn provided on the second half.

Such a variant accordingly for example includes that, in the case of a rectangular tile component, a base body with a respective fixing element is provided in the region of each corner, and the reference point lies on the intersection point of the diagonally running first and second force action lines. The passage openings of the four base bodies are then oriented towards precisely this reference point. The fixing elements, which are provided for example in the form of (threaded) bolts, are thus positioned at or in the vicinity of the diagonally opposite corners of the tile component. Thus the fixing elements lie on the action lines of the thermal expansions.

In principle, the reference point may be an imaginary central point of fixing elements standing in force equilibrium to each other. Alternatively, a further central fixing element is provided at the reference point for fixing the tile component to the combustion chamber component. A corresponding central fixing element is then received for example on the combustion chamber component in a typically round passage opening which has as little play as possible, e.g. in the form of a bore in the combustion chamber component In this way, the central fixing element may be supported on the opening edge of the combustion chamber component in order to counter the shear forces which are produced via the eccentrically provided fixing elements in operation of the engine. An eccentrically provided fixing element may in contrast for example be held in a slot on the combustion chamber component. In this way, a free shift of the fixing element is ensured under the differing thermal expansions of the tile component and combustion chamber component during operation of the engine, and guarantees that the fixing element is not (excessively) loaded, in particular pressed, against the combustion chamber component.

A further central fixing element may in principle also be provided at the platform of a further central base body, which protrudes from the cold side and below the platform of which at least one cavity is also provided, which is open towards the cold side via at least one side passage opening on the base body. Also thus improved cooling is provided at the central fixing element via a corresponding base body. In this context, in order to specifically reduce or keep low the local stresses which may occur at the central base body when high temperatures prevail on the hot side of the tile component in operation of the engine, at least one side passage opening of the further central base body may be oriented towards a passage opening of a base body of an eccentrically provided fixing element. This includes for example that the at least one side passage opening of the further central base body is oriented relative to a force action line such that, in a top view onto the cold side, the at least one side passage opening of the further central base body is intersected by the force action line. In a possible refinement, a connecting axis passing through two points on an outermost peripheral line of the respective base body, which constitute the intersection points of a contour of the side passage opening of the central base body with the outermost peripheral line, may run at an angle of 90° to the force action line. Accordingly, a projected opening area of the passage opening thus runs as perpendicularly as possible to the force action line.

If several passage openings distributed along the periphery are provided on the central base body for cooling the cavity below the platform, the passage openings are as far as possible oriented such that each of the passage openings of the central base body faces a passage opening of an eccentric base body. In some cases, the number of passage openings is adapted accordingly, for example also increased or reduced relative to a reference number (e.g. four passage openings), in order to provide a corresponding orientation and hence arrangement of the central base body on the cold side of the tile component.

In principle, at least one base body of an eccentrically provided fixing element may also have several (at least two) side passage openings, between which a respective connecting region runs which connects the associated platform to the cold side of the tile component. In the case of several side passage openings on one (centrally or eccentrically arranged) base body, the number of passage openings may be even or uneven. An even number of passage openings, advantageously spaced equidistantly relative to each other and provided along a periphery of the respective base body, may here for example be advantageous for balancing the load along the periphery of the base body. However, in the context of the proposed solution, it is not absolutely essential to provide an even number of passage openings, in particular spaced equidistantly apart.

The geometry of the tile component, in particular on the cold side, may be the reason why at least two eccentrically provided fixing elements have different distances from the reference point. The individual base bodies thus for example do not lie on a circular line about the reference point. This may be the case in particular for a tile component which is longitudinally extended in one spatial direction.

The proposed solution in principle also includes an engine, in particular a gas turbine engine for an aircraft, with a proposed combustion chamber assembly.

Furthermore, a method is proposed for producing a combustion chamber assembly for an engine with at least the following steps:
provision of a tile component with a cold side, and
provision of four fixing elements for fixing the tile component to a combustion chamber component, in each case eccentrically, on the cold side,

wherein for each fixing element, the tile component has a base body protruding from the cold side and having a platform on which the respective fixing element is fixed and below which at least one cavity is provided, which is open towards the cold side via at least one side passage opening on the base body. The four fixing elements may here be fixed to the respective base body by molding, for example during of additive production, or by subsequent fixing, e.g. welding. The at least four base bodies for the at least four eccentrically arranged fixing elements are here distributed about a central region of the tile component, relative to the extension of the tile component along the two mutually perpendicular spatial directions, so that in each case, two base bodies each with a fixing element are provided on different halves of the tile component relative to a center line extending in a first spatial direction of the two mutually perpendicular spatial directions. In the same way as a proposed combustion chamber assembly, in the context of the proposed production method, the four base bodies are oriented with their respective at least one side passage opening towards a reference point lying on the center line, so that the cavity of the respective base body is open in the direction of the reference point lying in the central region.

The tile component provided according to the proposed method, for example in the form of a combustion chamber tile, may then be placed on assigned fixing openings of a combustion chamber component via the at least four fixing elements and fixed thereto, wherein then because of the selected arrangement of the base bodies, smaller local stresses are observed during operation of the engine in the region of the fixing elements used and the tile component in itself is loaded more evenly.

In the context of a proposed production method, in particular a proposed combustion chamber assembly can be produced. Accordingly, the advantages and features mentioned above and below for design variants of a proposed combustion chamber assembly thus also apply to design variants of a proposed production method, and vice versa.

The appended figures illustrate exemplary possible design variants of the proposed solution.

In the figures:

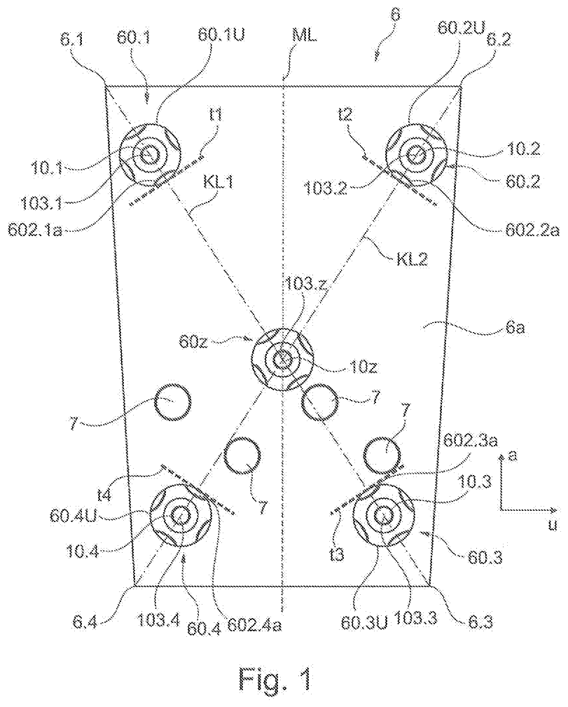

FIG. 1 shows an embodiment variant of a tile component in the form of a combustion chamber tile of a proposed combustion chamber assembly, viewed onto a cold side, with a central base body for a central (threaded) bolt and four eccentrically distributed base bodies, also with a respective (threaded) bolt;

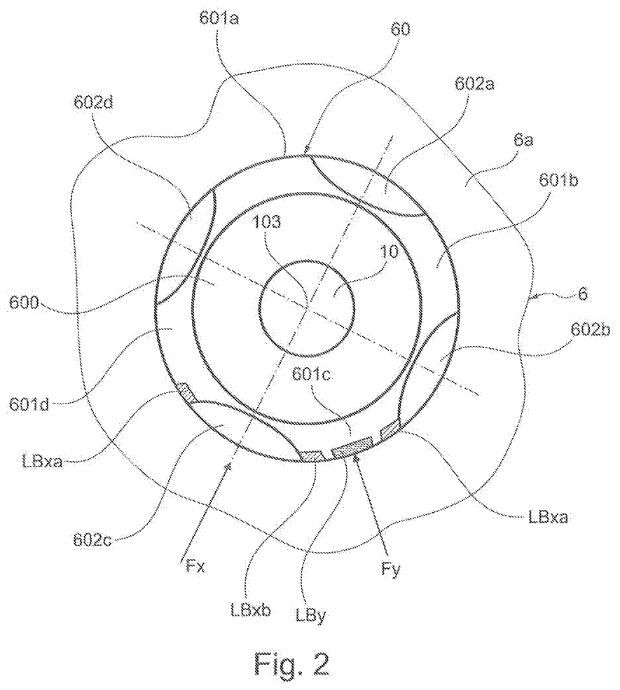

FIG. 2 shows an individual base body on enlarged scale;

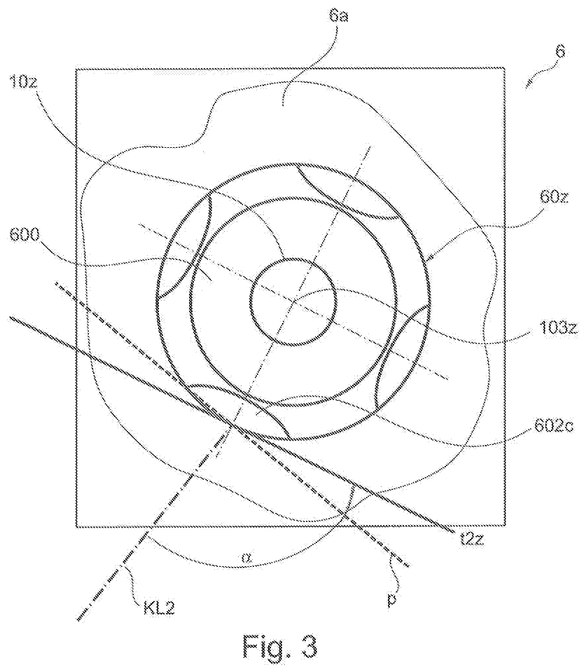

FIG. 3 shows a central base body in top view and individually;

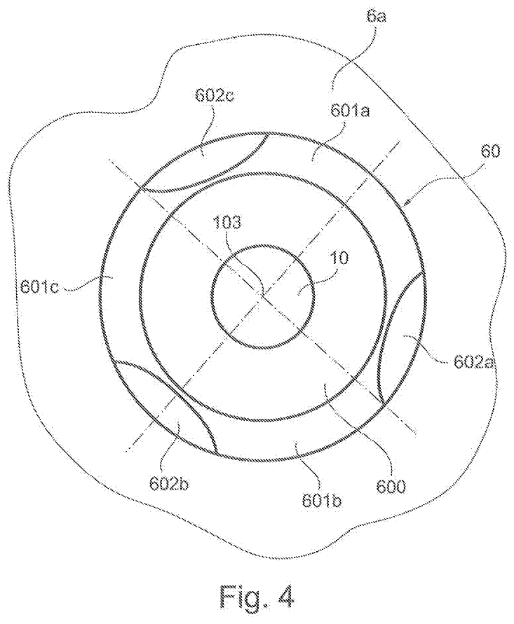

FIG. 4 shows an alternative design of base body with three (instead of four) side passage openings;

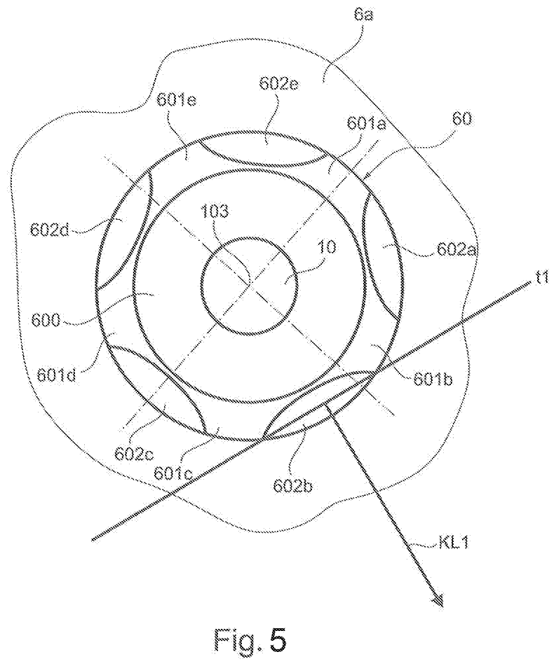

FIG. 5 shows, in a view corresponding to FIG. 4, a further alternative embodiment of a base body with five side passage openings;

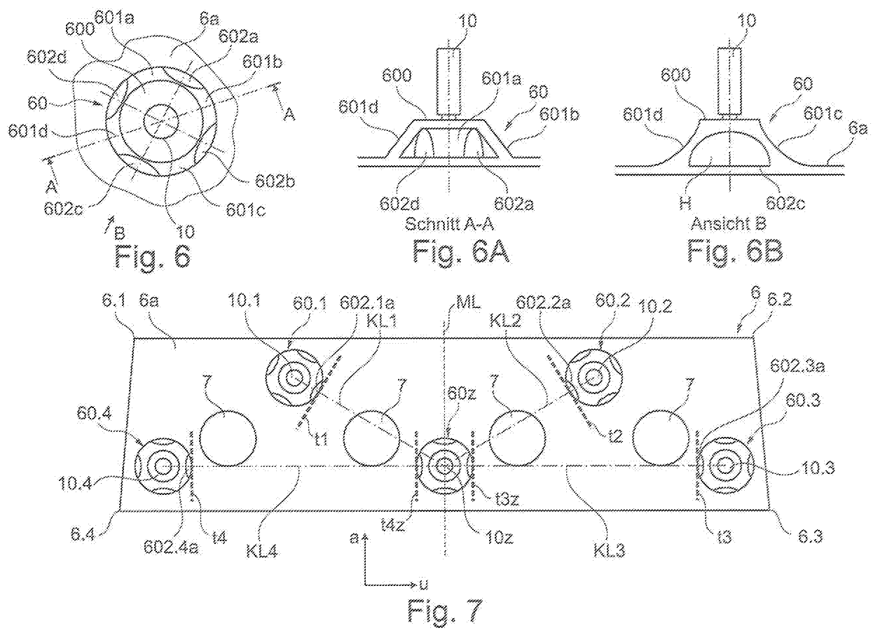

FIG. 6 shows the base body FIG. 2 again in top view;

FIG. 6A shows a sectional view along section line A-A from FIG. 6;

FIG. 6B shows a side view corresponding to the observation direction B from FIG. 6;

FIG. 7 shows an alternative design of combustion chamber tile, viewed onto its cold side, for an embodiment variant of the proposed combustion chamber assembly;

FIG. 8 shows a view of the base body with threaded bolts, according to FIG. 6;

FIGS. 8A and 8B show depictions of the base body with threaded bolts along section line A-A from FIG. 8 and in observation direction B from FIG. 8;

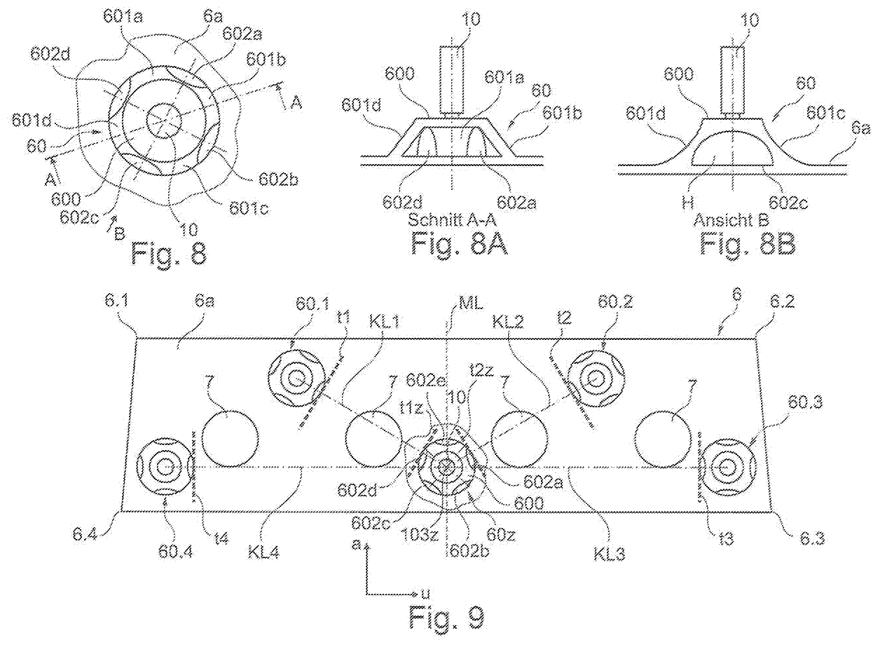

FIG. 9 shows, in a view corresponding to FIG. 7, a refinement of the embodiment in FIG. 7 with a central base body with five side passage openings;

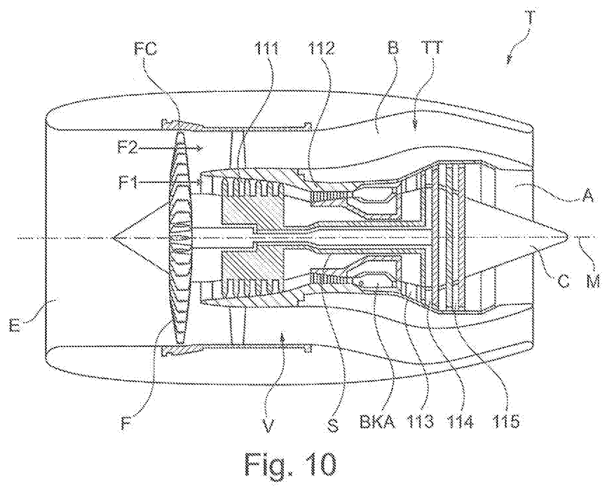

FIG. 10 shows an engine in which a combustion chamber tile corresponding to FIGS. 1 to 9 is used;

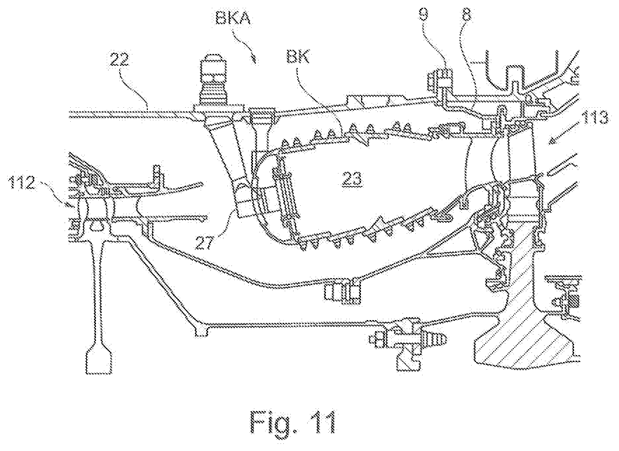

FIG. 11 shows, on an enlarged scale, a segment of a combustion chamber of the engine of FIG. 10;

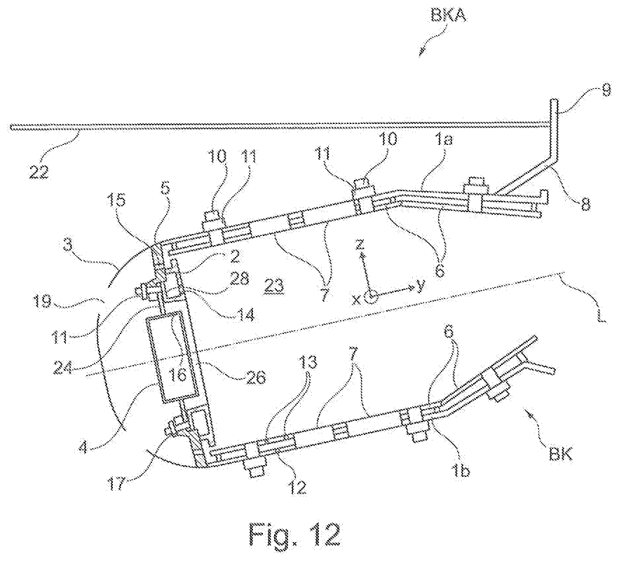

FIG. 12 shows, in cross-sectional view, the fundamental structure of a combustion chamber, again on an enlarged scale in comparison with FIG. 11.

FIG. 10 illustrates, schematically and in a sectional illustration, an engine T in which the individual engine components are arranged one behind the other along an axis of rotation or central axis M, and the engine T is formed as a turbofan engine. At an inlet or intake E of the engine T, air is drawn in along an inlet direction by means of a fan F. This fan F, which is arranged in a fan casing FC, is driven by means of a rotor shaft S which is set in rotation by a turbine TT of the engine T. Here, the turbine TT adjoins a compressor V, which comprises for example a low-pressure compressor 111 and a high-pressure compressor 112, and possibly also a medium-pressure compressor. The fan F on one side conducts air in a primary air flow F1 to the compressor V, and on the other side, to generate thrust, in a secondary air flow F2 to a secondary flow duct or bypass duct B. The bypass channel B here runs around a core engine comprising the compressor V and the turbine TT and comprising a primary flow duct for the air supplied to the core engine by the fan F.

The air conveyed into the primary flow duct by means of the compressor V passes into a combustion chamber portion BKA of the core engine, in which the drive energy for driving the turbine TT is generated. For this purpose, the turbine TT has a high-pressure turbine 113, a medium-pressure turbine 114 and a low-pressure turbine 115. Here, the energy released during the combustion is used by the turbine TT to drive the rotor shaft S and thus the fan F in order to generate the required thrust by means of the air conveyed into the bypass duct B. Both the air from the bypass duct B and the exhaust gases from the primary flow duct of the core engine flow out via an outlet A at the end of the engine T. In this arrangement, the outlet A generally has a thrust nozzle with a centrally arranged outlet cone C.

In principle, the fan F can also be coupled, via the rotor shaft S and an additional epicyclic planetary gear mechanism, to the low-pressure turbine 115 and can be driven by the latter. It is furthermore also possible to provide other, differently designed gas turbine engines in which the proposed solution can be used. For example, engines of this type may have an alternative number of compressors and/or turbines and/or an alternative number of rotor shafts. As an example, the engine may have a split-flow nozzle, meaning that the flow through the bypass duct B has its own nozzle, which is separate from and situated radially outside the core engine nozzle. However, this is not limiting, and any aspect of the present disclosure may also apply to engines in which the flow through the bypass duct B and the flow through the core are mixed or combined before (or upstream of) a single nozzle, which may be referred to as a mixed-flow nozzle. One or both nozzles (whether mixed or split flow) can have a fixed or variable area. While the example described relates to a turbofan engine, the proposed solution may be applied for example to any type of gas turbine engine, such as an open-rotor engine (in which the fan stage is not surrounded by an engine nacelle) or a turboprop engine.

FIG. 11 shows a longitudinal section through the combustion chamber portion BKA of the engine T. This shows in particular an (annular) combustion chamber BK of the engine T. A nozzle assembly is provided for the injection of fuel or an air-fuel mixture into a combustion space 23 of the combustion chamber BK. Said nozzle assembly comprises a combustion chamber ring, on which multiple fuel nozzles 27 are arranged along a circular line around the central axis M. Here, on the combustion chamber ring, there are provided the nozzle outlet openings of the respective fuel nozzles 27 which are situated within the combustion chamber BK. Here, each fuel nozzle 27 comprises a flange by means of which a fuel nozzle 27 is screwed to an outer housing 22 of the combustion chamber section BKA.

FIG. 12, in a further enlarged scale compared with FIG. 11 and in sectional view, shows a combustion chamber BK known from the prior art and in particular the configuration provided here of a burner seal 4 and a heat shield 2 in the region of a combustion chamber head 3 of the combustion chamber BK. The illustrated combustion chamber BK is in this case for example a (fully) annular combustion chamber such as is used in gas turbine engines.

The combustion chamber BK is arranged in the interior of the outer casing 22. The combustion chamber BK comprises, as combustion chamber components, a combustion chamber structure surrounding the combustion space 23, (radially) outer and (radially) inner combustion chamber walls 1a and 1b. These combustion chamber walls 1a, 1b are, depending on construction, shielded from the combustion space 23 in some cases with tile components in the form of combustion chamber tiles 6. These combustion chamber tiles 6 may for example each be connected to the inner and outer combustion chamber walls 1a, 1b by means of fixing elements in the form of bolts 10 and nuts 11. The combustion chamber walls 1a and 1b normally have cooling holes 12 and supply openings in the form of mixing air holes 7. A combustion chamber tile 6 may also be provided with effusion cooling holes 13. An outer combustion chamber wall 1a is connected to the outer casing 22 via an arm 8 and a flange 9.

A combustion chamber head 3, with a further combustion chamber component of the combustion chamber structure in the form of a head plate 5, is provided in a front end of the combustion chamber BK relative to a longitudinal axis L. The outer and inner combustion chamber walls 1a and 1b are connected together via this combustion chamber head 3 and the head plate 5. The head plate 5 shown here comprises cooling holes 15. Furthermore, a supply opening 26 is formed on the head plate 5 which provides access to the combustion space 23 and in which the fuel nozzle 27 is provided.

A burner seal 4 ensures the positioning of the fuel nozzle 27 in the head plate 5, and in particular in the supply opening 26 of the head plate 5. The burner seal 4 is here arranged radially in the head plate 5 and movable in the peripheral direction in order to be able to absorb component tolerances and thermal expansions. The burner seal 4, which may also be provided with cooling holes 16, is accordingly mounted in floating fashion and, in the illustrated embodiment variant from the prior art, is positioned on the head plate 5 by means of a front positioning part in the form of a front positioning ring 24, and positioned on the head plate 5 by means of a rear positioning part in the form of a rear positioning ring 28. Furthermore, the burner seal 4 is fixed via a heat shield 2 lying in the combustion space 23 and bolted to the head plate 5. For this, the heat shield 2 forms fixing elements in the form of bolts 17 which are guided through fixing openings on the head plate 5 and screwed on to the nuts 11 from the side of the combustion chamber head 3. Access for mounting the nuts 11 is provided via holes 19 in the combustion chamber head 3. According to the depiction in FIG. 12, the heat shield 2 may also have cooling air holes 14 and cooling ribs or studs. The bolts 17 may also be designed as separate components and need not be formed by the heat shield 2. Such bolts 17 are then for example screwed into threaded openings of the heat shield 2 from the side of the combustion chamber head 3.

FIGS. 1 to 9 now illustrate different embodiment variants for the proposed solution, in which as an example, for a combustion chamber tile 6, several base bodies 60z and 60.1-60.4 are provided on a cold side 6a of the combustion chamber tile 6 and oriented in a specific fashion relative to each other, in order to reduce local stresses and ensure a symmetrical load on individual bolts 10z, 10.1 to 10.4 for fixing a combustion chamber tile 6 to a combustion chamber wall 1a or 1b.

The combustion chamber tile 6 here has a rectangular form and extends in two extension directions a and u. The first extension direction a is here defined as the extension along the longitudinal axis L according to FIG. 12. A second extension direction u running perpendicularly thereto gives the extension of the combustion chamber tile 6 in mounted state along the peripheral direction pointing about the longitudinal axis L. The (threaded) bolts 10z and 10.1 to 10.4, provided for fixing, are provided on respective protruding base bodies 60z, 60.1-60.4 on the rectangular cold side 6a facing the combustion chamber wall 1a and 1b. Each of these base bodies 60z, 60.1-60.4 has a platform 600 on which one end of the respective bolt 10z, 10.1-10.4 is fixed, for example molded or welded. Each platform 600 is connected to the cold side 6a via connecting regions. Below each platform 600 is a cavity H (see in particular FIGS. 6A, 6B, 8A and 8B) which is open towards the cold side 6a of the combustion chamber tile 6 via several passage openings. Via the passage openings and the cavity H, a cooling air flow can be achieved through the respective base body 60z, 60.1-60.4 for cooling the respective bolt end 10z, 10.1-10.4 and hence at the fixing point thus defined.

The passage openings provided for flow through the base bodies 60z, 60.1-60.4, which in the exemplary embodiment of FIG. 1 are arranged equidistantly distributed around a circular periphery of the respective base body 60z, 60.1-60.4, may lead to shear loads and local stress concentrations at the connecting regions of a base body 60z, 60.1-60.4 in operation of the engine, because of different thermal expansions of the combustion chamber wall 16a or 61b and the combustion chamber tile 6. This is illustrated in more detail with reference to FIG. 2 as an example.

FIG. 2 shows on enlarged scale a base body 60 which is representative of each of the base bodies 60z, 60.1-60.4 of FIG. 1. The vertically protruding bolt 10 which extends along a longitudinal axis 103 is provided centrally on the platform 600 of the base body 60. The longitudinal axis 103 thus predefines a central fixing point for the combustion chamber tile 6. The base body 60 in FIG. 2 has four passage openings 602a to 602d distributed around the periphery of the base body 60. Connecting regions 601a to 601d are provided between these passage openings 602a to 602d and connect the platform 600 to the cold side 6a.

Because of the passage openings 602a to 602d, with an arrangement of the base body 60 not oriented according to the proposed solution, due to the force acting in a load direction Fy on the base body 60 in operation of the engine T, shear loads occur on a load region LBy in a central portion of a connecting region 601a to 601d which adjoins the respective passage openings 602a to 602d and the cold side 6a. The associated load concentrations may substantially reduce the service life of the combustion chamber assembly and in particular the respective bolt 10 under certain circumstances. The arrangement in FIG. 1 counters this in targeted fashion by suitable arrangement of the base bodies 60z, 60.1-60.4. This ensures that in operation of the engine T, a force acts on the base body 60 along a load direction Fx which points centrally to a passage opening 602c (here shown as an example) and through this. In the top view of FIG. 2 therefore, the (optimized) load direction Fx thus runs offset to the load direction Fy by an angle of 45° about the longitudinal axis 103. The force acting along the load direction Fx on a passage opening 602c thus leads to loads in the load regions LBxa, LBxb on the edge of the passage opening 602c. The loads are lower than the loads in the load region LBy provoked by the forces acting in the load direction Fy. As long as the force acting along the load direction Fx is as far as possible oriented in the region of 90° to a connecting axis t1-t4, this gives an improved service life, as will be explained in more detail below.

Thus four base bodies 60.1-60.4 with their respective bolts 10.1-10.4 lie eccentrically in corner regions 6.1-6.4 of the combustion chamber tile 6. In this way, two base bodies 6.1, 6.4 and 6.2, 6.3 in each case lie on a respective half of the combustion chamber tile 6 separated by a center line L running parallel to the extension direction a. A central base body 10z is arranged on this center line L at an intersection point of diagonal force action lines KL1 and KL2, which respectively connect together diametrically opposing corners of the combustion chamber tile 6. Two base bodies 6.1 and 6.3, and 6.2 and 6.4, thus in each case lie in different halves of the combustion chamber tile 6 on a respective force action line KL1 or KL2, so that the respective longitudinal axes 103.1-103.4 of the bolts 10.1-10.4 intersect these force action lines KL1 and KL2 perpendicularly. A longitudinal axis 103z of the central bolt 10z thus passes, at the central base body 60z, through the intersection point of the diagonally running force action lines KL1 and KL2.

The longitudinal axis 103z of the central bolt 10z in the top view of FIG. 1 forms a reference point, towards which the respective passage openings 602.1a to 602.4a of the base bodies 60.1-60.4 arranged eccentrically around the reference point are oriented. A connecting axis t1-t4 as a projected opening area of the respective passage opening 602.1a to 602.4a here runs perpendicularly to the respectively assigned force action line KL1 or KL2. On each base body 60.1-60.2, the connecting axis t1-t4 connects two points at which an outer contour (in this case elliptical and visible in top view) of a side passage opening 602.1a to 602.4a intersects an outermost peripheral line 60.1U-60.4U of the respective base body 60.1-60.4.

Because of the arrangement of the base bodies 60z, 60.1-60.4 and their associated bolts 10z, 10.1-10.4 shown in FIG. 1, the bolts 10.1-10.4 lie on the action lines of the thermal expansions, with the central bolt 10z as the reference point for thermal expansion. The central bolt 10z is here for example received in a circular bore on the respective combustion chamber wall 1a or 1b, in order to counter, by support on a bore edge, any shear forces applied from the corner regions 6.1-6.4. The eccentrically arranged bolts 10.1-10.4 are in contrast each held in a slot in the respective combustion chamber wall 1a or 1b, in order in principle to prevent the respective bolt 10.1-10.4 from going to stop in the case of a free shift thereof.

In order furthermore to keep the stress concentrations on the central bolt 10z and its central base body 60z as low as possible, its passage openings are also oriented at a specific angle to the force action lines KL1 and KL2. FIG. 3 illustrates this as an example for a passage opening 602c on the central base body 60z. A connecting axis t2z on this passage opening 602c here does not run perpendicularly to the force action line KL2, but in any case within a defined angular range from 60° to 120°, in particular in a range from 80° to 100°, as illustrated by an angle α between the force action line KL2 and the connecting axis t2z. Thus the angle α should as far as possible lie in the region of 90°, and the connecting axis t2z should as far as possible coincide with a reference axis p running perpendicularly to the force action line KL2, since otherwise (greater) stress peaks could occur in the load regions LBxa, LBxb and LBy illustrated in FIG. 2.

As illustrated in FIGS. 4 and 5, in particular with respect to such stress concentrations on the central base body 60z, it could be suitable to vary the number of passage openings on the base body 60z for through-flow of the cavity H, so as to facilitate orientation towards the respective force action lines KL1, KL2 and/or the reference point 103z as proposed. FIG. 4 here shows in top view a base body 60 with three passage openings 602a to 602c distributed equidistantly over the periphery. FIG. 5 again shows a base body 60 with five passage openings 602a to 602e here distributed equidistantly over the periphery.

Using the depictions in FIGS. 6, 6A and 6B and the corresponding views in FIGS. 8, 8A and 8B, in particular via FIGS. 6A, 6B and 8A, 8B, the structure of a respective base body 60z, 60.1-60.4 is illustrated using an exemplary base body 60.

FIGS. 7 and 9 in turn show a further embodiment variant with a combustion chamber tile 6, which in comparison with the combustion chamber tile 6 of FIG. 1 is also rectangular but here has a significantly shorter length in the extension direction a. The combustion chamber tile 6 in FIGS. 7 and 9 is thus configured so as to be elongate along the second extension direction u. The combustion chamber tile 6 in FIGS. 7 and 9 thus appears significantly extended in the peripheral direction u, and for example has a half axial length over 1.5, 2, 2.5 or 3 circumferential sectors of the combustion chamber BK.

With a combustion chamber tile 6 with the dimensions shown in FIGS. 7 and 9, the eccentric base bodies 60.1-60.4 with their bolts 10.1-10.4 are not provided only in the corner regions 6.1-6.4 and hence on two force action lines which intersect at a central intersection point. By deviation from the diagonal arrangement of FIG. 1, the embodiment variants of FIGS. 7 and 9 instead provide the arrangement of just two base bodies 60.4 and 60.3 in two corner regions 6.4 and 6.3. The respective one further base body 60.1 or 60.2 in each half of the combustion chamber tile 6 separated by the center line ML is then provided offset in the axial direction a and peripheral direction u relative to the other base body 60.4 or 60.3 of the same half. The central base body 60z with the central bolt 10z is however again provided on the center line ML. Here however, firstly at an intersection point of the center line ML with an axis linking the longitudinal axes of the bolts 10.4 and 10.3 assigned to the corner regions 6.3 and 6.4. Force action lines KL3 and KL4 between the central bolt 10z and the respective eccentric bolt 10.4 or 10.3 of the respective corner region 6.4 or 6.3 run parallel to this axis. Further force action lines KL1 and KL2 extend from the central bolt 10z to the two further bolts 10.1 and 10.2. As an example, the force action lines KL4, KL1 or KL3, KL2 for two base bodies 60.4, 60.1 or 60.3, 60.2 of half the combustion chamber tile 6 here run at an angle of around 30° to each other.

In the embodiment variants of FIGS. 7 and 9, a passage opening 602.1a to 602.4a of the eccentric base body 60.1-60.4 is also oriented towards the central reference point of the central bolt 10z (defined by its longitudinal axis 103z); in the present case, such that the individual connecting axes t1 to t4 each run perpendicularly to the respectively assigned force action line KL1 to KL4.

In the embodiment variant of FIG. 7, the base body 60z for the central bolt 10z has four passage openings around the periphery, whereby only two of these passage openings with connecting axis t3z, t4z run perpendicularly to the two force action lines KL3, KL4. The respective passage openings are thus oriented, with comparatively great deviation from the perpendicular, towards the further force lines KL1 and KL2 of the base bodies 60.1 and 60.2 lying closer to the central base body 60z.

In this respect, the exemplary embodiment of FIG. 9 illustrates the possibility of providing an odd number of passage openings and hence connecting regions, instead of an even number. Thus for example, a passage opening 602a or 602d of the central base body 60z may face the two base bodies 60.2, 60.3 or 60.1, 60.4 of a half of the combustion chamber tile 6 such that the connecting axes t2z or t1z for the passage openings 602a and 602d of the central base body 60z have an almost 90° orientation for both decisive force action lines KL2, KL3 or KL1, KL4, and in particular are oriented at an angle in the range from 80° to 100° to both respective force action lines KL2, KL3 or KL1, KL4.

### LIST OF REFERENCE SIGNS

1a, 1b (Outer/inner) combustion chamber wall
10, 10.1-10.4, 10z Bolt (fixing element)
103, 103.1-103.4, 103z Fixing point/longitudinal axis of fixing element
103z Fixing point/reference point
11 Nut
111 Low-pressure compressor
112 High-pressure compressor
113 High-pressure turbine
114 Medium-pressure turbine
115 Low-pressure turbine
12 Cooling hole
13 Effusion cooling hole
14 Cooling air hole
15 Cooling hole
16 Cooling hole
17 Bolt (fixing element)
19 Hole
2 Heat shield (tile component)
22 Outer housing
23 Combustion space
24 Front positioning ring
26 Passage hole (passage opening)
27 Fuel nozzle
28 Rear positioning ring
3 Combustion chamber head
4 Burner seal
5 Head plate (combustion chamber component)
6 Combustion chamber tile (tile component)
6.1-6.4 Corner region
60, 60.1-60.4, 60z Base body/bridge
60.1U-60.4U Peripheral line
600, 600.2 Platform
601a-601e Connecting region
602.1a-602.4a Passage opening
602a-602e Passage opening
6a Cold side
7 Mixing air hole (supply opening)
8 Arm
9 Flange
a (Axial) extension direction
A Outlet
B Bypass duct
BK Combustion chamber
BKA Combustion chamber portion
C Outlet cone
E Inlet/Intake
F Fan
F1, F2 Fluid flow
FC Fan casing
Fx, Fy Load direction
H Cavity
KL1-KL4 Force action line
L Longitudinal axis
LBxa, LBxb, LBy Load region
M Central axis/axis of rotation
ML Center line
p Reference axis
S Rotor shaft
T (Turbofan) engine
t1-t4, t1z-t4z Connecting axis
TT Turbine
u (Peripheral) extension direction
V Compressor
α Angle

1. A combustion chamber assembly for an engine, with at least
a combustion chamber component of a combustion chamber structure surrounding a combustion space, and
a tile component fixed to the combustion chamber component and having a hot side facing a combustion space and a cold side facing away from the combustion space and facing towards the combustion chamber component, and extending along two mutually perpendicular spatial directions,
wherein the tile component on the cold side has at least four fixing elements each arranged eccentrically on the tile component for fixing the tile component to the combustion chamber component,
wherein for each fixing element, the tile component has a base body protruding from the cold side and having a platform on which the respective fixing element is fixed and below which at least one cavity is provided, which is open towards the cold side via at least one side passage opening on the base body, and
wherein the at least four base bodies for the at least four eccentrically arranged fixing elements are distributed about a central region of the tile component relative to the extensions of the tile component along the two mutually perpendicular spatial directions, so that in each case two base bodies, each provided with a fixing element, are provided on different halves of the tile component relative to a center line extending in a first spatial direction of the two mutually perpendicular spatial directions,
wherein
the four base bodies are here oriented with their respective at least one side passage opening towards a reference point lying on the center line, so that the cavity of the respective base body is open in the direction of the reference point.

2. The combustion chamber assembly according to claim 1, wherein in top view onto the cold side, an outer contour of each side passage opening of the four base bodies intersects an outermost peripheral line of the respective base body at two points, and a connecting axis through these two points runs at an angle in the range from 60° to 120° to a force action line which connects the reference point to a longitudinal axis of the fixing element of the respective base body.

3. The combustion chamber assembly according to claim 1, wherein the reference point is provided at an intersection point of a first force action line and a second force action line, wherein in top view onto the cold side
the first force action line runs from a first longitudinal axis of a first fixing element of a first base body, provided on a first half of the tile component, to a third longitudinal axis of a third fixing element of a third base body provided on a second half, and
the second force action line runs from a second longitudinal axis of a second fixing element of a second base body, also provided on the first half of the tile component, to a fourth longitudinal axis of a fourth fixing element of a fourth base body which is also provided on the second half.

4. The combustion chamber assembly according to claim 1, wherein at the reference point, a further central fixing element is provided for fixing the tile component to the combustion chamber component.

5. The combustion chamber assembly according to claim 4, wherein in the further central fixing element is provided at the platform of a further central base body which protrudes from the cold side, and below the platform of which at least one cavity is also provided which is open towards the cold side via at least one side passage opening on the base body.

6. The combustion chamber assembly according to claim 5, wherein on the further central base body, several side passage openings are arranged which are distributed around the reference point.

7. The combustion chamber assembly according to claim 5, wherein in at least one side passage opening of the further central base body is oriented towards a passage opening of a base body of an eccentrically arranged fixing element.

8. The combustion chamber assembly according to claim 2, wherein the at least one side passage opening of the further central base body is oriented relative to a force action line such that, in a top view onto the cold side, the at least one side passage opening of the further central base body is intersected by the force action line.

9. The combustion chamber assembly according to claim 1, wherein at least one base body of an eccentrically arranged fixing element has several side passage openings, between which runs a respective connecting region which connects the associated platform to the cold side of the tile component.

10. The combustion chamber assembly according to claim 6, wherein an even number of passage openings is provided which are equidistantly spaced from each other.

11. The combustion chamber assembly according to claim 1, wherein at least two eccentrically arranged fixing elements have different distances from the reference point.

12. The combustion chamber assembly according to claim 1, wherein the tile component is formed rectangular in top view onto the cold side, and at least two eccentrically arranged fixing elements are situated in different corner regions of the tile component.

13. The combustion chamber assembly according to claim 1, wherein at least one of the eccentrically arranged fixing elements is held in a slot on the combustion chamber component.

14. An engine with at least one combustion chamber assembly according to claim 1.

15. A method for producing a combustion chamber assembly for an engine with at least the following steps:
provision of a tile component with a cold side, and
provision of four fixing elements for fixing the tile component to a combustion chamber component, in each case eccentrically, on the cold side,
wherein for each fixing element, the tile component has a base body protruding from the cold side and having a platform on which the respective fixing element is fixed and below which at least one cavity is provided, which is open towards the cold side via at least one side passage opening on the base body, and
wherein the at least four base bodies for the at least four eccentrically arranged fixing elements are distributed about a central region of the tile component relative to the extensions of the tile component along the two mutually perpendicular spatial directions, so that two base bodies each with a fixing element are provided on different halves of the tile component relative to a center line extending in a first spatial direction of the two mutually perpendicular spatial directions,
wherein
the four base bodies are here oriented with their respective at least one side passage opening towards a reference point lying on the center line, so that the cavity of the respective base body is open in the direction of the reference point.
